(19) United States
(12) Patent Application Publication
(10) Pub. No.: US 2008/0088578 A1
(43) Pub. Date: Apr. 17, 2008

(54) FLEXIBLE OBJECT SIMULATOR

(75) Inventors: Milan Ikits, Gaithersburg, MD (US); Donald Nelson, Vancouver (CA); Christopher J. Ullrich, Santa Cruz, CA (US)

Correspondence Address: WOMBLE CARLYLE SANDRIDGE & RICE, PLLC, ATTN: PATENT DOCKETING 32ND FLOOR, P.O. BOX 7037, ATLANTA, GA, 30357-0037, US

(73) Assignee: Immersion Corporation, San Jose, CA (US)

(21) Appl. No.: 11/549,834

(22) Filed: Oct. 16, 2006

(51) Int. Cl. G09G 5/00

(52) U.S. Cl. 345/156; 345/161

(57) ABSTRACT

A method of simulating a flexible object such as a catheter includes modeling the flexible object as a plurality of segments in which each segment has a plurality of nodes connected by one or more edges. The method further includes modeling each segment as a plurality of tetrahedral elements formed by the nodes and the edges to generate a tetrahedral finite element model. The method further includes indexing each node so that a maximum difference between a first index of a first node and a second index of a second node is bounded and is approximately equal to s*k, where s is the maximum number of segments connected at one node and k is a maximum number of nodes that belong to one segment.

### GOVERNMENT LICENSE RIGHTS

The U.S. Government has a paid-up license in this invention and the right in limited circumstances to require the patent owner to license others on reasonable terms as provided for by the terms of Grant No. DMI-0239344 awarded by the National Science Foundation.

### FIELD OF THE INVENTION

One embodiment of the present invention is directed to a simulator of a flexible object. More particularly, one embodiment of the present invention is directed to a medical device simulator for simulating catheters and other wire-like structures.

### BACKGROUND INFORMATION

The growth of minimally invasive therapies has led to a growing interest in the potential for computer-based simulation for training. Many computer-based medical simulators have been designed to teach these new techniques. Most of these efforts have focused on laparoscopic surgery, in which rigid tools are inserted into the patient's abdomen and visual feedback is provided by an endoscopic camera that produces a high-definition color image. These simulators are predominantly skills trainers, emphasizing the two-dimensional hand-eye coordination practice that is useful for laparoscopic surgery.

Interventional cardiology shares characteristics with other minimally invasive therapies that make it suitable for simulator-based learning: it requires complex understanding of three-dimensional anatomy from two-dimensional displays and fine hand-eye coordination. As with surgery, complications from improperly performed cardiac catheterization can have catastrophic results, thus there is a strong need for simulator based training before an actual procedure is attempted.

However, interventional cardiology simulation presents unique challenges. First, visual feedback is not provided by visible light but by fluoroscopy, which must be simulated in real time while allowing for changes in points of view as the fluoroscope moves around the patient. Second, the catheters, guide wires, and stents are flexible devices and therefore must be modeled as deformable objects, which is not the case for rigid laparoscopic tools. To control the motion of a catheter or guide wire within the vascular network, the physician can only push, pull or twist the proximal end of the device. Since such devices are constrained inside the patient's vasculature, it is the combination of input forces and contact forces that allow them to be moved toward a target.

The main characteristics of wire-like structures or flexible objects that simulation models attempt to capture include geometric non-linearities, high tensile strength and low resistance to bending. However, many known flexible object simulation models are not suitable for real-time applications.

Known models for flexible objects used in the context of medical simulation include articulated body methods (“ABM”), which represent the object as a set of rigid segments connected by rotary and torsional springs (see, e.g., Dawson et al., “Designing a Computer-Based Simulator for Interventional Cardiology Training”, Catheterization and Cardiovascular Interventions 51:522-527 (2000)). However, since these methods use explicit integration, they do not provide the necessary stiffness and speed as required by many applications. In addition, stability is affected by the length of the smallest segment.

Other known models for flexible objects use beam finite elements (see, e.g., Cotin et. al., “New Approaches to Catheter Navigation for Interventional Radiology Simulation”, MICCAI (2005)). However, these methods exhibit problems similar to the articulated body method, due to using explicit integration and iterative solution techniques.

Based on the foregoing, there is a need for a system and method for modeling and simulating a flexible object for use in computer-based simulations.

### SUMMARY OF THE INVENTION

One embodiment of the present invention is a method of simulating a flexible object such as a catheter. The method includes modeling the flexible object as a plurality of segments in which each segment has a plurality of nodes connected by one or more edges. The method further includes modeling each segment as a plurality of tetrahedral elements formed by the nodes and the edges to generate a tetrahedral finite element model. The method further includes indexing each node so that a maximum difference between a first index of a first node and a second index of a second node is bounded and is approximately equal to s*k, where s is the maximum number of segments connected at one node and k is a maximum number of nodes that belong to one segment.

### BRIEF DESCRIPTION OF THE DRAWINGS

FIG. 1 is a perspective diagram of a system for simulating a flexible object in accordance with one embodiment of the present invention.

FIG. 2 illustrates one segment of the flexible object to be simulated.

FIG. 3 illustrates how each prism is further decomposed into three tetrahedral elements by inserting additional edges.

FIG. 4 illustrates two consecutive segments and corresponding nodes and illustrates the node indexing scheme in accordance with one embodiment of the present invention.

FIG. 5 is a flow diagram of the functionality performed by the computer of FIG. 1 to simulate a flexible object such as a catheter in accordance with one embodiment of the present invention.

FIG. 6 graphically illustrates the banded structure of the system matrix A in accordance with one embodiment of the present invention.

FIG. 7 illustrates a resulting simulated tetrahedral model in accordance with one embodiment of the present invention.

FIG. 8 illustrates an actual simulated catheter as seen by a user in accordance with one embodiment of the present invention.

### DETAILED DESCRIPTION

One embodiment of the present invention is a method and system for physically-based modeling and interactive simulation of flexible objects such those used or encountered in medical procedures. The objects are modeled using finite elements with a linear elastic material model and corotational warping.

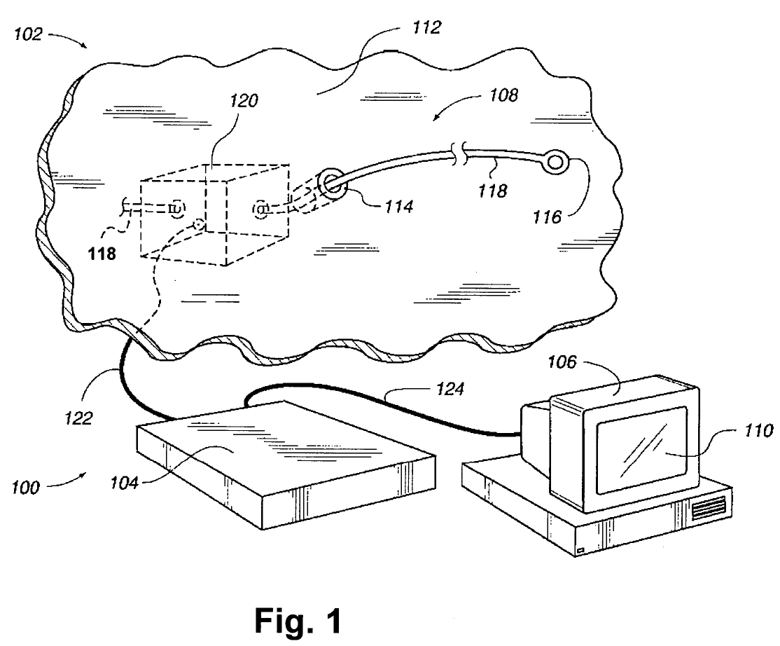

FIG. 1 is a perspective diagram of a system 100 for simulating a flexible object in accordance with one embodiment of the present invention. System 100 is used to simulate a catheter during a medical procedure, but can be used to simulate any flexible object. System 100 includes a human/computer interface 102, a electronic interface 104 and a computer 106.

A catheter 108 is manipulated by a user and virtual reality images are displayed on a monitor 110 of computer 106 in response to such manipulations. Computer 106 can be any type of general purpose or specialized computer that includes a processor and a memory for storing instructions that are executed by the processor.

In addition to a catheter 108, human/computer interface 102 includes a barrier 112 and a “central line” 114 through which catheter 108 is inserted into the “body”. Barrier 112 is used to represent the portion of the skin covering the body of a patient. In one embodiment, barrier 112 is formed from a mannequin or other life-like representation of a body or body portion (e.g., the torso, arm or leg). Central line 114 is inserted into barrier 112 to provide an entry and removal point from barrier 112 for catheter 108, and to allow the manipulation of the distal portion of catheter 108 within the body of the patient while minimizing tissue damage. Catheter 108 can be any commercially available catheter, although in one embodiment the end of catheter 108 is removed to prevent any potential damage to persons or property since it is not required for the medical simulation.

Catheter 108 includes a handle or “grip” 116 and a shaft 118. Grip 116 can be any conventional device used to manipulate catheter 108, or grip 116 may comprise shaft 118 itself. Shaft 118 is an elongated flexible object and, in particular, is an elongated cylindrical object. System 100, in order to simulate catheter 108, tracks the movement of shaft 118 in three-dimensional space, where the movement has been constrained such that shaft 118 has only two, three or four degrees of motion. This is a feasible simulation of the typical use of a catheter because once the catheter is inserted into a patient's body, it is limited to about two degrees of freedom at some point along its length.

A haptic interface 120 receives shaft 118 and applies haptic feedback on shaft 118 that can be felt by the user and provides the user with a sensation that catheter 108 is entering an actual body. In one embodiment, haptic interface 120 includes one or more actuators and other devices that generate the haptic feedback. Haptic interface 120 can be any known device for generating haptic feedback on shaft 118, including the haptic interface disclosed in U.S. Pat. No. 5,821,920. Haptic interface 120 also determines the position of catheter 108 within the simulated body, including whether catheter 108 is being pushed, pulled or twisted by the user at grip 116.

Electronic interface 104 receives position information from haptic interface 120 via cable 122, and transmits the information to computer 106 via cable 124. In response, computer 106 models the position of catheter 108, as disclosed in more detail below, and generates a graphical image of the simulation on monitor 110. Further, computer 106 generates the required haptic effects based on the position of catheter 108, and provides signals to haptic interface 120 to generate the haptic effects that are felt by the user.

In simulating a flexible object such as catheter 108, one embodiment of the present invention initially uses a tetrahedral decomposition and node indexing method for creating a finite element model. Embodiments of the present invention then perform a fast simulation of the model using a direct numerical solver.

In one embodiment, the flexible object to be simulated is modeled as a serial chain of connected segments that form a segmented space curve. Each segment has length, radius, and material parameters associated with it in addition to two angles that specify the orientation of the segment relative to the previous segment in the chain. In one embodiment, it is assumed that the object has a circular cross-section, although in other embodiments different shapes can be modeled.

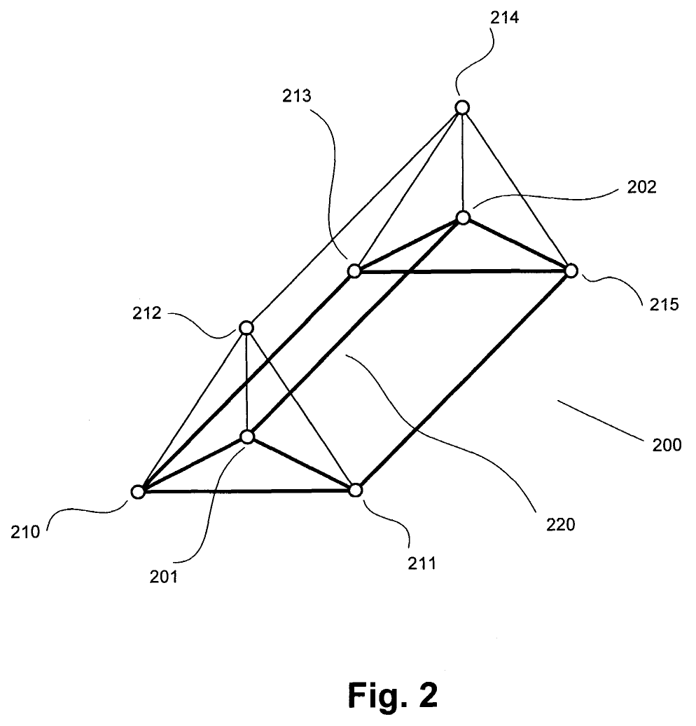

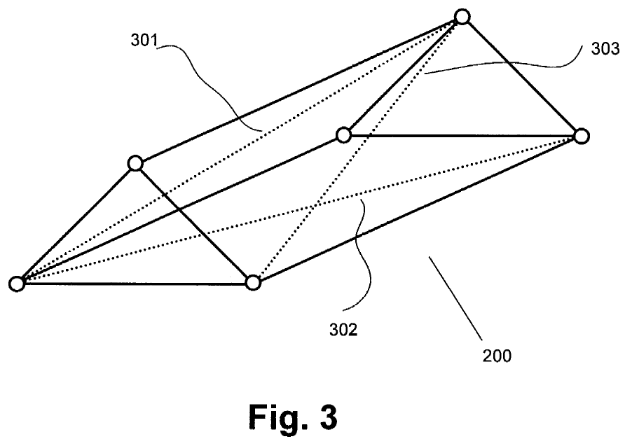

FIG. 2 illustrates one segment 200 of the flexible object to be simulated. Each segment is connected by segment nodes 201, 202 along the centerline or space curve 220 of the object to additional segments. Additional surrounding nodes 210-215 are placed around the segment nodes 201, 202 to form the segments. Each segment is then decomposed into triangular prisms by connecting the nodes with edges according to the pattern shown in FIG. 2. FIG. 3 illustrates how each prism is further decomposed into three tetrahedral elements by inserting additional edges 301-303.

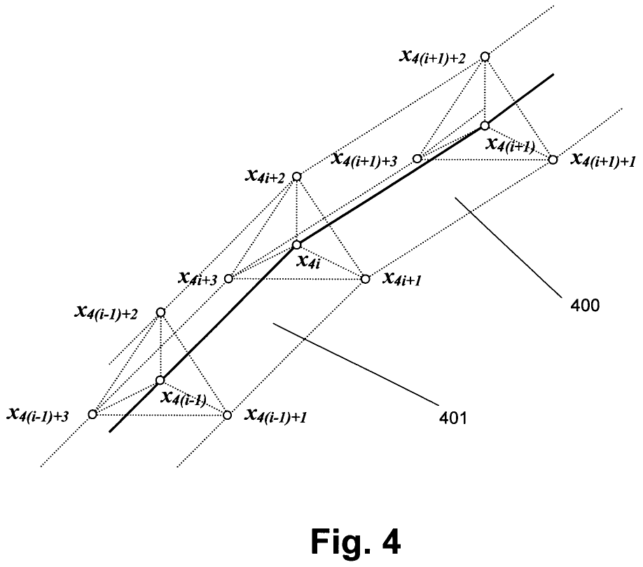

FIG. 4 illustrates two consecutive segments 400 and 401 and corresponding nodes and illustrates the node indexing scheme in accordance with one embodiment of the present invention. The nodes are indexed so the difference between the indexes of two nodes connected by an edge remains bounded by a constant that is small relative to the total number of nodes in the object. In one embodiment, indexes are assigned in increasing order on a segment by segment basis. As shown in FIG. 4, if k−1 nodes are placed around each centerline node, the nodes belonging to segment i are assigned indexes ki,ki+1, . . . ,ki+k−1. The indexing method yields a maximum difference of 2k−1 between the indexes of two nodes connected by an edge. A similar scheme can be developed for non-tubular objects.

In one embodiment, maximum difference between the indexes of two nodes is bounded by s*k where s is the maximum number of segments connected at a node and k is the maximum number of nodes that belong to a segment. Therefore, for catheters and other long flexible objects, the bound is 2*k.

In one embodiment, the connectivity of the segments are modeled by a connected undirected graph “G” in which each segment is represented by a graph edge and all object nodes connecting two segments are represented by a graph node. Each object node is indexed so that a maximum difference between a first index of a first object node and a second index of a second object node is bounded by (1+b̂l)*k, where the first object node and the second object node are connected by an object edge, “l” is the number of branching levels of the spanning tree “T” of the connectivity graph,“b” is the maximum number of children for a node in the spanning tree T, and “k” is the maximum number of object nodes that belong to a segment. In this embodiment, the following parameters may apply for embodiments of the object to be simulated:

(1) Linear connectivity: b=1, l=0→2*k;

(2) A single loop: b=2, l=1→3*k;

(3) Two loops connected at a node: b=4, l=1→5*k;

(4) Two loops connected at an edge: b=3, l=2→10*k (this is not a tight bound, since it is also bounded by 5*k);

(5) Full 3-level binary tree: b=2, l=3→9*k.

One embodiment of the present invention simulates the motion of a flexible object by constantly calculating the position of the nodes surrounding each segment, such as the nodes shown in FIG. 4. The motion of the object is governed by Newton's second law:

Ma=f(x,v)

where x, v, and a are vectors containing the positions, velocities and accelerations of the nodes, M is a matrix representing the mass distribution in the object, and f includes the internal and external forces acting at the nodes. In one embodiment, the position of each of the nodes is updated based on the forces acting on the object at highly interactive rates (e.g.,>30 Hz). In one embodiment, this is accomplished by numerical integration of the equations of motion using a semi-implicit time-stepping method, such as disclosed in Baraff and Witkin, “Large Steps in Cloth Simulation”, SIGGRAPH (1998) (“Baraff”).

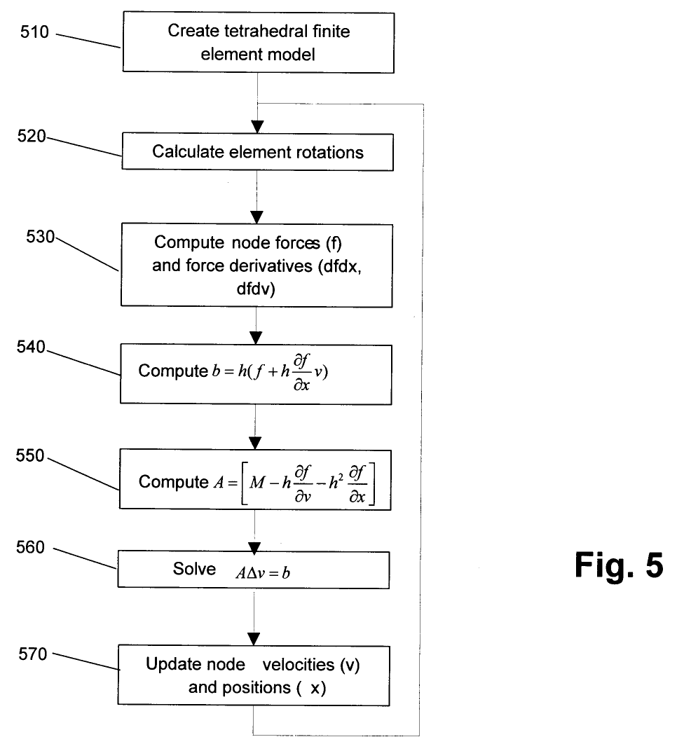

FIG. 5 is a flow diagram of the functionality performed by computer 106 of FIG. 1 to simulate a flexible object such as catheter 108 in accordance with one embodiment of the present invention. In one embodiment, the functionality of FIG. 5 is implemented by software stored in memory and executed by a processor. In other embodiments, the functionality can be performed by hardware, or any combination of hardware and software.

At 500, a tetrahedral finite element model and index is created for the flexible object to be simulated. In one embodiment, the tetrahedral finite element model is created as disclosed in conjunction with FIGS. 2-4 above.

At 520, the element rotations are calculated. In one embodiment, the rotations are calculated using a corotational warping method such as disclosed in Mueller and Gross, “Interactive Virtual Materials”, Graphics Interface (2004).

At 530, the node forces (f) and force derivatives (∂f/∂x and ∂f/∂v) are computed. In one embodiment, the node forces and force derivatives are computed using a semi-implicit time-stepping method, such as disclosed in Baraff.

At 540, “b” is computed for a given step h as

$$b = h ( f + h \frac{\partial f}{\partial x} v ) .$$

### In one embodiment, b is computed using a semi-implicit time-stepping method, such as disclosed in Baraff.

At 550, “A” is computed for a given step h as

$$A = [ M - h \frac{\partial f}{\partial v} - {h}^{2} \frac{\partial f}{\partial x} ] .$$

### In one embodiment, A is computed using a semi-implicit time-stepping method, such as disclosed in Baraff.

At 560, the following linear system is solved based on the computed A and b values: AΔν=b. In one embodiment, a direct solver is used to solve the linear system. In one embodiment, the direct solver is a banded Cholesky matrix decomposition algorithm, such as disclosed in Gene H. Golub and Charles F. Van Loan “Matrix Computations”, Johns Hopkins University Press, p. 156 (1996). At 570, the result of the solution at 560, Δν, is used to update the node positions and velocities in the simulation loop. The loop then returns to 520.

The modeling and simulation of flexible objects as disclosed in FIG. 5 provides many advantages relative to the prior art. For one, the implicit integration provides the necessary stability and performance that is required for a high frequency dynamic response. A similar level of stability and performance is not possible to achieve with explicit integration methods. Further, more accurate volume conservation is provided by corotational warping relative to using a linear FE model. Volume conservation results in a more realistic physical behavior of the simulated object.

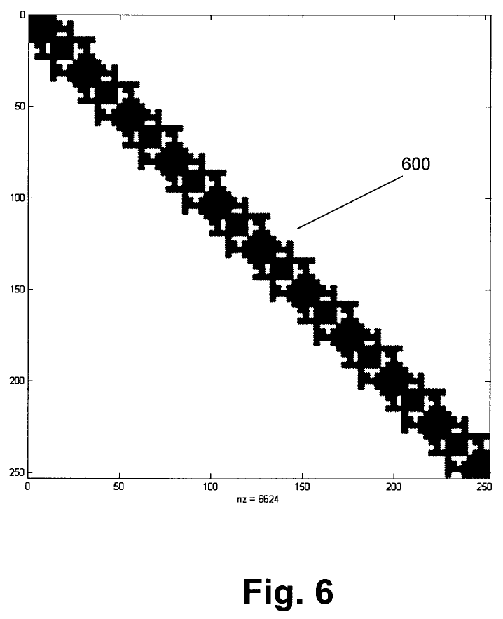

In addition, the result of the tetrahedral finite element model and index disclosed in conjunction with FIGS. 2-4 above is that the bandwidth of the system matrix A is 2k−1. Therefore, the model in accordance with one embodiment yields a very sparse matrix with low bandwidth, which permits the use of a direct numerical solver. FIG. 6 graphically illustrates the banded structure of the system matrix A in accordance with one embodiment of the present invention. As shown, the non-zero matrix elements are all within a bounded distance to the diagonal 600. The banded structure of the system matrix A is a direct consequence of the node numbering method. A banded solver exploits the banded structure of the matrix to solve the system AΔν=b more quickly.

In prior art methods, the linear system AΔν=b is typically solved via iterative methods, such as the conjugate gradient method. In contrast, embodiments of the present invention efficiently solve the linear system obtained from the model in FIGS. 2-4 using a banded Cholesky matrix decomposition algorithm. The direct solver outperforms prior art iterative solvers due to the connectivity of the mesh, which results from the indexing of the nodes. In one embodiment, the run-time complexity of the algorithm is O(m²n), where n is the number of segments and m=6 k−3 is the bandwidth of the system matrix A. In one embodiment, the nonzero elements of the system matrix are stored in a linear array in computer memory along with an array of two dimensional indexes specifying the positions of the elements in the matrix and a two dimensional array of pointers with nonzero pointers referring to elements in the one dimensional arrays. In one embodiment, the banded Cholesky algorithm is modified, so the zero elements generated during the executing of the algorithm are removed from the two dimensional pointer array.

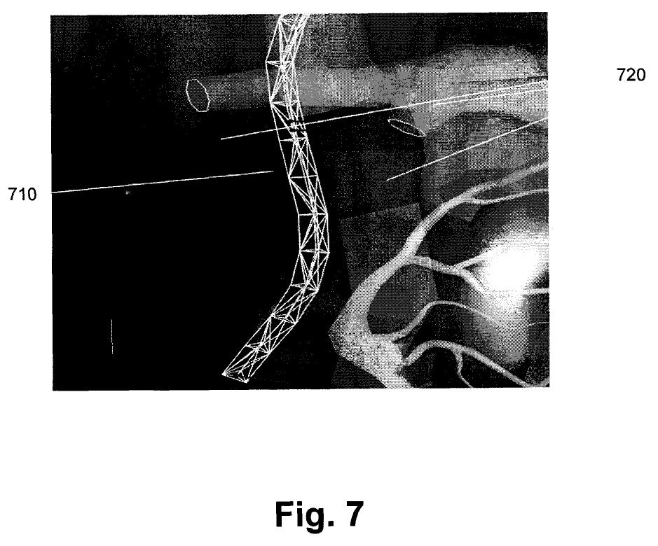

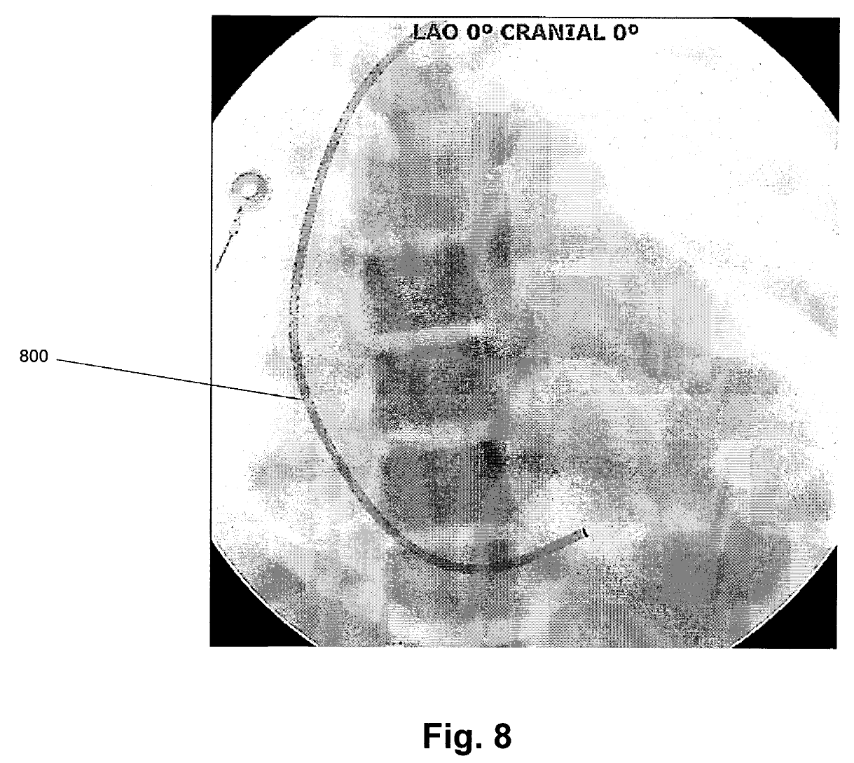

FIG. 7 illustrates a resulting simulated tetrahedral model in accordance with one embodiment of the present invention. The model 710 is shown juxtaposed with simulated body organ parts 720 such as a heart, veins, arteries, etc. The actual simulated catheter 800 seen by a user in accordance with one embodiment of the present invention is shown in FIG. 8

As disclosed, one embodiment of the present invention simulates a flexible object such as a catheter by creating a tetrahedral finite element model and indexing of the nodes and then executing a fast simulation of the model using a direct numerical solver. The result is an efficient and realistic simulation of the object.

Several embodiments of the present invention are specifically illustrated and/or described herein. However, it will be appreciated that modifications and variations of the present invention are covered by the above teachings and within the purview of the appended claims without departing from the spirit and intended scope of the invention.

What is claimed is:

1. A method of simulating a flexible object comprising:
modeling the object as a plurality of segments, each segment having a plurality of nodes connected by one or more edges;
modeling each segment as a plurality of tetrahedral elements formed by the nodes and the edges to generate a tetrahedral finite element model; and
indexing each node so that a maximum difference between a first index of a first node and a second index of a second node is bounded and is approximately equal to s*k, wherein s is the maximum number of segments connected at one node and k is a maximum number of nodes that belong to one segment.

2. The method of claim 1, wherein said object comprises a segmented space curve and each segment is connected by a segment node along the space curve.

3. The method of claim 2, wherein each segment comprises a plurality of surrounding nodes around the segment node.

4. The method of claim 3, wherein at most k−1 surrounding nodes are placed around each segment node belonging to segment i and the surrounding nodes are assigned indexes ki,ki+1, . . . ,ki+k−1.

5. The method of claim 1, further comprising:
calculating for a first time period an element rotation for the tetrahedral finite element model.

6. The method of claim 5, wherein said calculating comprises corotational warping.

7. The method of claim 1, further comprising:
calculating for the first time period and for each node a force.

8. The method of claim 7, wherein said calculating comprises solving AΔν=b, and wherein A and b are computed using a semi-implicit time-stepping method.

9. The method of claim 8, wherein b is computed for a given step h as
$$b = h ( f + h \frac{\partial f}{\partial x} v ) ,$$
and A is computed for the given step h as
$$A = [ M - h \frac{\partial f}{\partial v} - {h}^{2} \frac{\partial f}{\partial x} ] .$$

10. The method of claim 8, wherein said solving comprises a direct solver.

11. The method of claim 10, wherein said direct solver is a banded Cholesky matrix decomposition algorithm.

12. The method of claim 11, wherein said direct solver is modified to remove zero elements generated during execution.

13. The method of claim 8, wherein A has a bandwidth of m=6 k−3.

14. The method of claim 1, wherein said flexible object is a catheter.

15. The method of claim 1, wherein said flexible object is a deformable body with a bounded distance to an approximating segmented space curve.

16. The method of claim 1, wherein said flexible object can be geometrically decomposed into a set of layers, where each layer is a deformable body with a bounded distance to an approximating segmented space curve.

17. The method of claim 1, wherein said flexible object is a deformable body with bounded distance to a set of segmented space curves, wherein a subset of the curve segments are connected to form a graph.

18. A computer readable medium having instructions stored thereon that, when executed by a processor, causes the processor to simulate a flexible object by:
modeling the object as a plurality of segments, each segment having a plurality of nodes connected by one or more edges;
modeling each segment as a plurality of tetrahedral elements formed by the nodes and the edges to generate a tetrahedral finite element model; and
indexing each node so that a maximum difference between a first index of a first node and a second index of a second node is bounded and is approximately equal to s*k, wherein s is the maximum number of segments connected at one node and k is a maximum number of nodes that belong to one segment.

19. The computer readable medium of claim 18, wherein said object comprises a segmented space curve and each segment is connected by a segment node along the space curve.

20. The computer readable medium of claim 19, wherein each segment comprises a plurality of surrounding nodes around the segment node.

21. The computer readable medium of claim 20, wherein at most k−1 surrounding nodes are placed around each segment node belonging to segment i and the surrounding nodes are assigned indexes ki,ki+1, . . . ,ki+k−1.

22. The computer readable medium of claim 18, said processor further:
calculating for a first time period an element rotation for the tetrahedral finite element model.

23. The computer readable medium of claim 22, wherein said calculating comprises corotational warping.

24. The computer readable medium of claim 18, said processor further:
calculating for the first time period and for each node a force.

25. The computer readable medium of claim 24, wherein said calculating comprises solving AΔν=b, and wherein A and b are computed using a semi-implicit time-stepping method.

26. The computer readable medium of claim 25, wherein b is computed for a given step h as
$$b = h ( f + h \frac{\partial f}{\partial x} v ) ,$$
and A is computed for the given step h as
$$A = [ M - h \frac{\partial f}{\partial v} - {h}^{2} \frac{\partial f}{\partial x} ] .$$

27. The computer readable medium of claim 25, wherein said solving comprises a direct solver.

28. The computer readable medium of claim 27, wherein said direct solver is a banded Cholesky matrix decomposition algorithm.

29. The computer readable medium of claim 28, wherein said direct solver is modified to remove zero elements generated during execution.

30. The computer readable medium of claim 27, wherein A has a bandwidth of m=6 k−3.

31. The computer readable medium of claim 18, wherein said flexible object is a catheter.

32. A system for simulating a flexible object comprising:
means for modeling the object as a plurality of segments, each segment having a plurality of nodes connected by one or more edges;
means for modeling each segment as a plurality of tetrahedral elements formed by the nodes and the edges to generate a tetrahedral finite element model; and
means for indexing each node so that a maximum difference between a first index of a first node and a second index of a second node is bounded and is approximately equal to s*k, wherein s is the maximum number of segments connected at one node and k is a maximum number of nodes that belong to one segment.

33. The system of claim 32, wherein said object comprises a segmented space curve and each segment is connected by a segment node along the space curve.

34. The system of claim 33, wherein each segment comprises a plurality of surrounding nodes around the segment node.

35. The system of claim 34, wherein at most k−1 surrounding nodes are placed around each segment node belonging to segment i and the surrounding nodes are assigned indexes ki,ki+1, . . . ,ki+k−1.

36. A system for simulating a flexible object comprising:
a processor;
a memory coupled to said processor; and
a display coupled to said processor;
wherein said memory stores instructions that when executed by the processor causes said processor to:
model the object as a plurality of segments, each segment having a plurality of nodes connected by one or more edges;
model each segment as a plurality of tetrahedral elements formed by the nodes and the edges to generate a tetrahedral finite element model;
index each node so that a maximum difference between a first index of a first node and a second index of a second node is bounded and is approximately equal to s*k, wherein s is the maximum number of segments connected at one node and k is a maximum number of nodes that belong to one segment and;
cause the simulated flexible object to be visible on the display.

37. The system of claim 36, wherein said object comprises a segmented space curve and each segment is connected by a segment node along the space curve.

38. The system of claim 37, wherein each segment comprises a plurality of surrounding nodes around the segment node.

39. The system of claim 38, wherein at most k−1 surrounding nodes are placed around each segment node belonging to segment i and the surrounding nodes are assigned indexes ki,ki+1, . . . ,ki+k−1.

40. The system of claim 36, wherein said flexible object is a catheter.

41. A method of simulating a flexible object comprising:
modeling the object as a plurality of segments, each segment having a plurality of object nodes connected by one or more object edges;
modeling each segment as a plurality of tetrahedral elements formed by the object nodes and the object edges to generate a tetrahedral finite element model;
modeling the connectivity of the segments by a connected undirected graph G, wherein each segment is represented by a graph edge and all object nodes connecting two segments are represented by a graph node; and
indexing each object node so that a maximum difference between a first index of a first object node and a second index of a second object node is bounded by (1+b̂l)*k, wherein said first object node and said second object node are connected by an object edge, l is a number of branching levels of a spanning tree T of the graph G, b is a maximum number of children for one node in the spanning tree T, and k is the maximum number of object nodes that belong to one segment.

42. A method of simulating a flexible object comprising:
modeling the object as a plurality of segments, each segment having a plurality of nodes connected by one or more edges;
modeling each segment as a plurality of tetrahedral elements formed by the nodes and the edges to generate a tetrahedral finite element model; and
indexing each node so that a maximum difference between a first index of a first node and a second index of a second node is bounded and is approximately less than half of an amount of the plurality of nodes, wherein said first node and said second node are connected by an edge.
